(19) United States
(12) Patent Application Publication
(10) Pub. No.: US 2021/0131355 A1
(43) Pub. Date: May 6, 2021

(54) CONTROL METHOD AND SYSTEM IN A HYBRID-ELECTRICAL AIRCRAFT PROPULSION SYSTEM

(71) Applicants: Rolls-Royce Deutschland Ltd & Co KG, Blankenfelde-Mahlow (DE); Rolls-Royce plc, London (GB)

(72) Inventors: Ivo SZARVASY, Stahnsdorf (DE); Erik JANKE, Berlin (DE); Rory STIEGER, Derby (GB)

(21) Appl. No.: 17/030,495

(22) Filed: Sep. 24, 2020

(30) Foreign Application Priority Data
Oct. 31, 2019 (DE) 10 2019 129 482.7

(51) Int. Cl. F02C 9/42; F02C 6/14; F01D 11/24; B64D 27/02

(52) U.S. Cl. CPC F02C 9/42; F02C 6/14; F01D 11/24; B64D 27/02; B64D 2027/026; F05D 2270/44; F05D 2220/76; F05D 2260/232; F05D 2270/051; F05D 2270/13; F05D 2270/305; F05D 2220/323

(57) ABSTRACT

A control method/system for a hybrid-electric aircraft propulsion system includes a generator, a propulsor, a controller and an electric storage unit. The generator including a gas turbine with blades separated from a casing by a clearance and driving an electric generator. An electric motor drives the propulsor. The controller controls the turbine and supply of electric power between the motor, the storage unit and the generator in response to a thrust demand and cooperates with a clearance controller: receives a command for a change in thrust demand; determines an operational profile that minimizes a function comprising a measure of fuel supplied to the turbine, transferring electric power from/to the storage unit, a difference between measures of current and demanded thrust and clearance over a time period; and operates the motor, turbine and storage unit according to the operational profile over the time period.

This application claims priority to German Patent Application DE102019129482.7 filed Oct. 31, 2019, the entirety of which is incorporated by reference herein.

### Description

The invention relates to a control method in a hybrid-electrical aircraft propulsion system with the features of claim 1 and a control system in a hybrid-electrical aircraft propulsion system with the features of claim 10.

Modern aircraft engines are commonly controlled by Full Authority Digital Engine Control (FADEC) Electronic Engine Controller (EEC) units, which host software configured to manage and control the engine. The control of an aircraft engine can also comprise some control of the gap between blades of a turbine and/or the compressor and their respective surrounding casing. The so-called tip clearance is a key loss contributor in the overall engine. The tip clearance levels are largely driven by the transient movements of casings relative to the rotating parts due to thermal and/or centrifugal loads.

Conventional aircraft engines based on gas turbines contain one or more shafts, with typical civil aircraft having two or three shafts. In a turbofan engine most of the thrust is generated by mechanical coupling of the low pressure (LP) turbine to the fan. Hence, turbofan engines are designed to have only one power source across their full operating and thrust range, from Maximum Takeoff thrust (MTO) via Cruise to Idle. Therefore, significant transient movements in particular in blades and casings cannot be avoided.

In hybrid-electric aircraft (comprising a hybrid-electric propulsion system with a gas turbine and an electric system), thrust can be generated by an electric motor instead of a gas turbine. In a turbofan engine, the electric motor can drive e.g. the fan. Electric power is provided to the electric motor from a battery, a fuel cell system and/or a generator, which may be driven by a gas turbine. An advantage of hybrid-electric propulsion is that the separate components of the fan and gas turbine engine can each be operated separately, resulting in overall fuel savings.

Tip clearance control is an issue in conventional engines as well as in gas turbines being part of hybrid-electric propulsion systems. In both cases, significant transient movements of the blades and the casing define a large portion of the overall tip clearance. Their effects can be reduced by active tip clearance control (TCC) systems using e.g. the controlled flow of cold or hot air to control the contraction or expansion of a casing surrounding compressor stages or turbine stages.

The tip clearance can also be addressed by design approaches adopting the time constants of static and rotating parts.

In general, tip clearances cannot be fully avoided, thereby leading to efficiency reductions, specific fuel consumption increase and increased levels of performance deterioration for shroudless turbine designs due to increasing hot gas over tip leakage with time.

The effect is more pronounced for small engines, where the absolute tip clearance is larger in percentage of the blade height.

In an aircraft propulsion system scenario where there is a need for a rapid change in thrust provided by a single source of thrust, e.g. from Idle to MTO, the conventional aircraft engine (e.g. a turbofan) has no other design degree of freedom than to provide the step change in thrust, thereby going through the aforementioned transients.

Therefore, systems and methods for system with various alternative power sources are required that can address tip clearance control in a hybrid-electric aircraft propulsion system.

This is addressed by a method with the features of claim 1.

The control method is operating with a hybrid-electric gas aircraft propulsion system comprising a generator system, a propulsor, a controller and an electric storage unit. The electric storage unit can e.g. comprise a battery or a fuel cell system.

The generator system comprises a gas turbine having a plurality of rotor blades surrounded by a casing, the rotor blades separated from the casing by a tip clearance. This part is essentially similar to a conventional combustion based gas turbine.

The generator system further comprises an electric generator arranged to be driven by the gas turbine, the propulsor, in particular a fan, with an electric motor arranged to drive the propulsor. The combination of a gas turbine driven part and the electrically driven part constitutes a hybrid-electric aircraft propulsion system.

The controller of the hybrid-electric aircraft propulsion system is configured to operate the gas turbine and to control the supply of electric power between the electric motor, the electric storage unit and the electric generator in response to a demand for thrust. The controller can adjust e.g. the outputs of the power coming from the gas turbine and the electrical system to meet certain conditions and constrains.

Here the controller is operated in cooperation with a tip clearance controller, i.e. the predicted tip clearance as function of the flight cycle condition is taken into account in the control of the overall system. This means that means for tip clearance control, such as air flows in the secondary air flow system can be used as manipulated variables to achieve an overall control objective.

The method can receive a command for a change in demand for thrust and then determine an operational profile that minimizes a function comprising a measure of fuel supplied to the gas turbine, a transfer of electric power from or to the electric storage unit, a difference between measures of current and demanded thrust and the tip clearance over a time period. This shows that the control method makes use inter alia of the tip clearance.

Then the electric motor, the gas turbine and electric storage unit are operated according to the determined operational profile over the time period.

In one embodiment the control method controls a step change in the operational profile at least in part so that it is performed by power obtained from the electrical storage unit. The use of electrical power and shaft power in generating step changes allows a higher flexibility, in particular for achieving an optimum tip clearance. The gas turbine can in particular provide a ramp-up change in the operational profile, while the power obtained from the electrical storage unit makes up the difference to the required power level to generate the step change in the operation profile.

In a further embodiment of the control method a decrease in thrust is generated by a step change for the gas turbine, the rotational energy available due to the decrease in the thrust being used to charge the electrical storage unit.

It is also possible that power obtained from the electrical storage unit is used to generate of gradual, quasi-steady increase in fuel flow, whilst the electrical system compensates for the difference in thrust by charging or discharging the electrical storage system.

The control method can also maintain the operational profile with the tip clearance at a predetermined tolerance, in particular a time dependent tolerance. The size of the tip clearance can vary over time so that the overall energy consumption of the hybrid-electric aircraft propulsion system is optimised.

In one embodiment the method comprises the controlling of the tip clearance between the rotor blades and the casing by controlling a supply of cooling and/or heating air to the casing and/or controlling movement of the casing relative to the rotor blades.

In one embodiment the control method is used in a hybrid-electric aircraft propulsion system as a part of a propulsion system of an aircraft or a helicopter.

The method can be implemented with a computer program for instructing a computer-implemented controller to perform the method of any one of claims 1 to 8.

The issue is also addressed by a control system with the features of claim 10.

The skilled person will appreciate that, except where mutually exclusive, a feature described in relation to any one of the above aspects may be applied mutatis mutandis to any other aspect. Furthermore, except where mutually exclusive, any feature described herein may be applied to any aspect and/or combined with any other feature described herein.

Embodiments will now be described by way of example only, with reference to the Figures, in which:

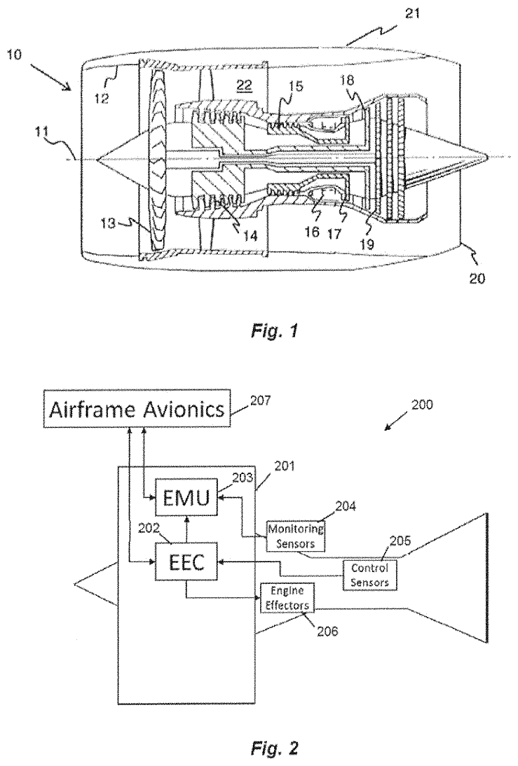

FIG. 1 is a sectional side view of a gas turbine engine;

FIG. 2 is a schematic diagram of a control system arrangement for a turbofan engine;

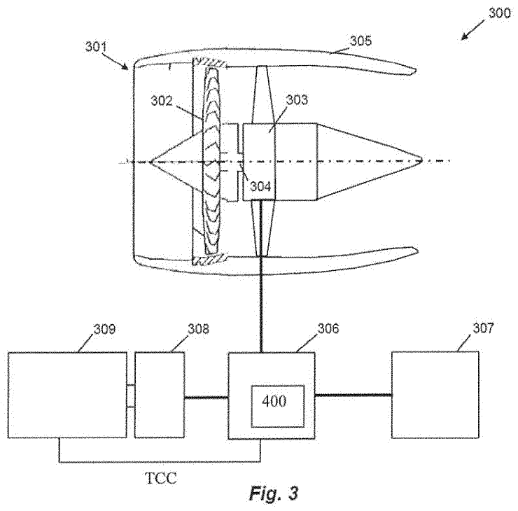

FIG. 3 is a schematic diagram of a hybrid-electric aircraft propulsion system for an aircraft;

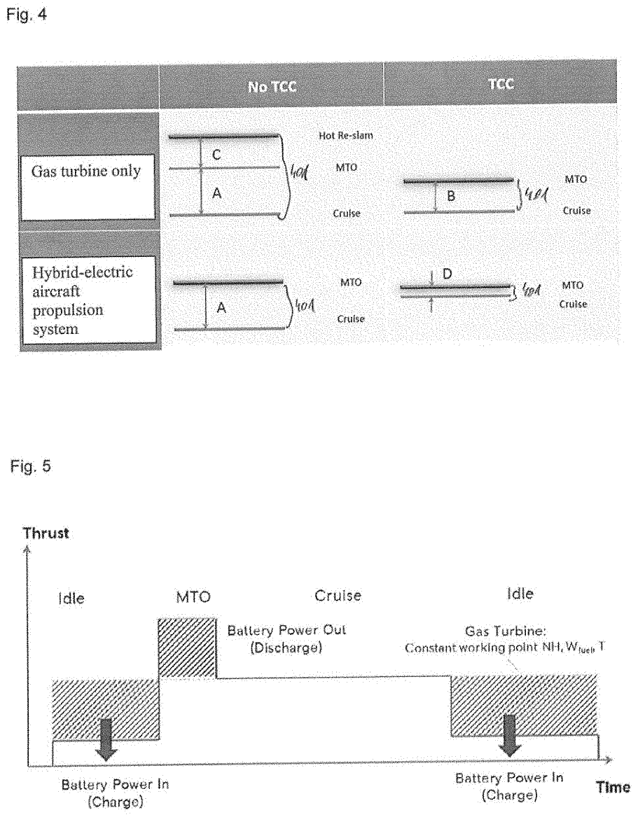

FIG. 4 is a comparison of the effect on tip clearance control on a conventional gas turbine engine and a hybrid-electric aircraft propulsion system;

FIG. 5 is a schematic thrust diagram for an operation profile of a hybrid-electric aircraft propulsion system known in the art;

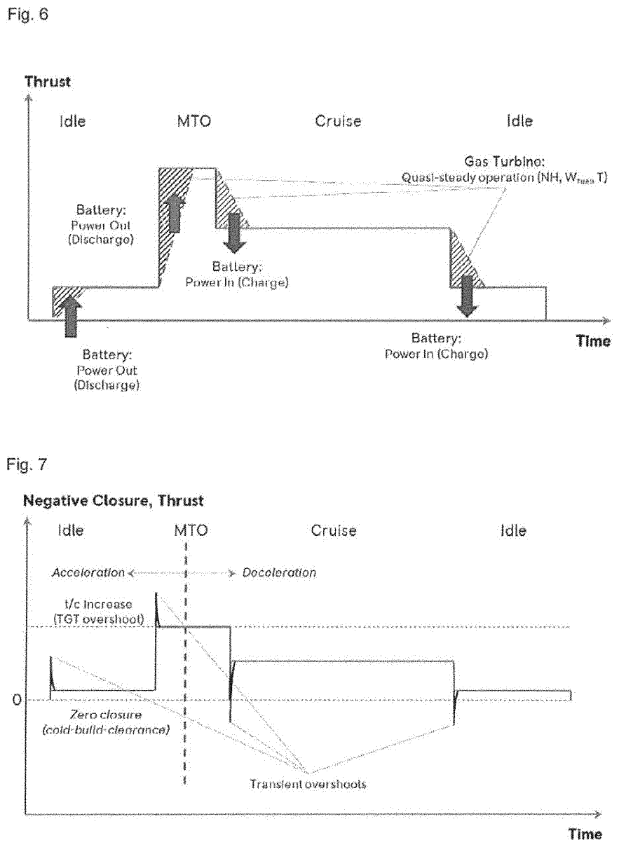

FIG. 6 is a schematic thrust diagram for an operation profile of a hybrid-electric aircraft propulsion system in which operational changes are performed using power taken from an electrical storage unit;

FIG. 7 is a schematic tip clearance gap diagram for an operation profile of a hybrid-electric aircraft propulsion system in which operational changes are performed using power taken from an electrical storage unit;

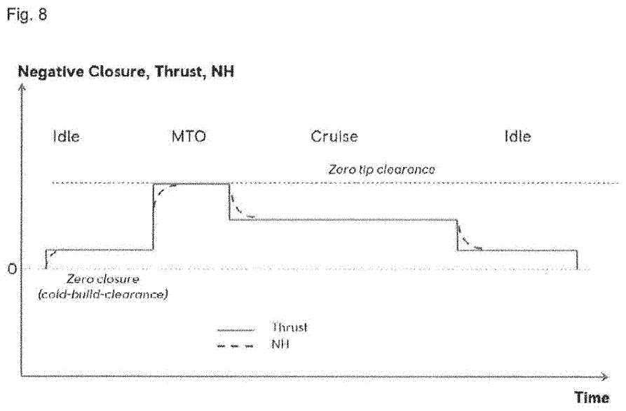

FIG. 8 is a schematic tip clearance gap diagram for an operation profile of a hybrid-electric aircraft propulsion system in which operational changes are performed using power taken from an electrical storage unit, whilst the gas turbine operates at constant conditions

With reference to FIG. 1, a gas turbine engine—here a turbofan engine—is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20.

A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high-pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high-pressure compressor 15, intermediate pressure compressor 14 and fan 13, each by suitable interconnecting shaft.

Other gas turbine engines, such as turbojet, turboprop or turboshaft engines, to which the present disclosure may be applied, may have alternative configurations.

By way of example, such engines may have an alternative number of interconnecting shafts (e.g. two) and/or an alternative number of compressors and/or turbines. Further, the engine may comprise a gearbox provided in the drive train from a turbine to a compressor and/or fan.

FIG. 2 illustrates an example control and monitoring system 200 for a conventional civil turbofan engine 201. The engine 201 is controlled by an engine electronic control (EEC) 202 and engine monitoring unit (EMU) 203. The EMU 203 takes inputs from monitoring sensors 204 and the EEC 202 from control sensors 205.

The EEC 202 controls operation of engine effectors 206 to control operation of the engine 201. The EMU 203 and EEC 202 are also connected to airframe avionics 207, having other controls, effectors and sensors for monitoring and control of other parts of the aircraft and for providing a demand for thrust to the engine 201.

In a control system for a hybrid-electric aircraft propulsion system, three aspects of control need to be addressed. Firstly, the hybrid-electric power train needs to be controlled in a way that takes into account operability constraints of the gas turbine engine. Secondly, control of the aircraft flight control system, particularly relating to control of thrust, needs to be integrated with the hybrid-electric power train. Thirdly, the flight management system needs to be integrated with the hybrid-electric power train.

A schematic diagram of a basic hybrid-electric aircraft propulsion system 300 is shown in FIG. 3. An electric propulsion unit or engine 301 comprises a fan 302 connected to an electric motor 303 by a central shaft 304. As with a conventional gas turbine engine, the engine 301 comprises a nacelle 305 surrounding the fan 302 and motor 303. The engine 303 is provided with electric power via power electronics in a controller 306, which is connected to an electric storage unit 307, which may include a battery, a fuel-cell system, a supercapacitor or a combination of the units.

The controller 306 is also connected to a generator 308 and a gas turbine engine 309. The gas turbine engine 309 drives the generator 308 to generate electric power, which the controller 306 distributes between the electric storage unit 307 and the electric motor 303. Under some conditions, the electric motor 303 may also act as a generator, for example, when a reduction in thrust is demanded and the forward movement of the engine 301 drives the fan 302 until a required fan speed is reached.

Energy may then be taken from the motor 303 and stored in the electric storage unit 307.

The controller 306 takes inputs from the aircraft control system (not shown), which provides a thrust or fan speed demand. The controller 306 then manages how the demand is achieved, by balancing use of the gas turbine engine 309 and generator 308 with the electric storage unit 307. For example, when a step increase in demand is received, the controller 306 may use the electric storage unit 307 to provide an immediate increase in electric power to the motor 303, while the gas turbine engine 309 is powered up more slowly to accommodate for the different behavior of the gas turbine 309. Once the gas turbine engine 309 has reached a required power output level, the balance of power taken from the generator 308 and electric storage unit 307 can be shifted so that all of the electric power comes from the generator 308, and an additional amount can be used to recharge the electric storage unit 307.

The ways in which the controller 306 can balance operation of the gas turbine engine 309 with the electric storage unit 307 depends on the particular characteristics of the gas turbine engine 309.

Typical gas turbine dynamics can be simplified into a set of two distinct groups that are relevant for fuel burn and a resulting cost of operation: shaft power dynamics and tip clearance dynamics (see e.g. FIG. 4).

Shaft power dynamics relate to the relationship between fuel supplied and the resulting shaft speed. Time constants of the order of 1 to 10 seconds may be involved in this relationship, leading to working line excursions and operability driven constraints.

Tip clearance dynamics are short-term changes in clearance between compressor and/or turbine blade tips and the surrounding casing. Changes in engine power level occurring at more than around 1 percent per second of the fan speed typically cannot be accurately tracked using current active tip clearance systems, which can result in either contact between the blade tips and the casing or a sub-optimum clearance between the tips and the casing. Increasing the tolerance between the blade tips and the casing can reduce this, but at the cost of significantly reduced efficiency. It would therefore be advantageous to be able to maintain tip clearance within a reduced tolerance while allowing for rapid changes in engine power.

Generally, tip clearance dynamics can be broken down in four time constants: segment growth, blade growth, casing growth and disc growth, all of which depend on the engine power level, with blade and disc growth also having centrifugal components proportional to the square of rotational speed. These dynamics are described in further detail in U.S. Pat. No. 9,546,564 to Lewis, the disclosure of which is hereby incorporated by reference herein.

As described in Lewis, when the engine is switched on it begins to heat up and the disc and blades begin to rotate, which causes all of the rotating components to grow radially. Due to the rotation of the blades and their relatively small mass, the rotor blades tend to grow more quickly, and substantially instantaneously, by a small amount.

The disc grows radially outwardly by a relatively large amount, for example three times as much as the rotor blades, and with a longer time constant of for example around 100 seconds.

The casing, which is relatively massive and does not rotate, grows by a relatively large amount, for example around three times as much as the rotor blades, but with a long time constant of for example around 50 seconds.

A segment assembly may define an inner surface of the casing, being composed of a plurality of discontinuous segments in a circumferential array. The segment assembly may actively or passively be controlled to move radially inwardly or outwardly to change the clearance between the blade tips and the segment assembly. The segment assembly grows by a small amount, for example, a third of the growth experienced by the rotor blades, but with a moderate time constant of for example around 15 seconds.

On heating, the segment assembly grows radially inwards, whereas the casing and disc grow radially outwards and the rotor blades grow radially outwards. The clearance therefore reduces during rapid acceleration and deceleration phases. To reduce the change in clearance it is known to provide active or passive tip clearance control arrangements, for example by providing cooling air to the casing to reduce its diameter or retard its growth. The segment assembly may alternatively be moved mechanically to alter the clearance. A method of actively controlling tip clearance is described in Lewis.

Hence, there are two separate power sources (electric storage unit 307, gas turbine engine 309) in a hybrid-electric aircraft propulsion system 300 with, for example, batteries or fuel-cells and shaft power-off take through a generator 308 or other electric devices.

A known concept for controlling a hybrid-electric aircraft propulsion system 300 is a design of the gas turbine engine 309 for the use in (relatively) steady state operations (such as e.g. cruise flight) and manage different thrust levels by using the electric energy stored in the electric storage unit 307 (e.g. batteries or fuel cells) to provide an additional power needed during MTO, or to re-charge the batteries during descent or idle thrust requirements.

In the following, methods and device are discussed in which a control of the hybrid-electric aircraft propulsion engine 300 is considered together with a tip clearance control system 400 coupled with the gas turbine engine 309, as schematically shown in FIG. 3. The controller 306 sends TCC control signals to the secondary airflow system in the gas turbine 390 to control the tip clearance 400 (not shown here) by e.g. adjusting cold or hot air flows in the relevant regions.

The overall objective function to operate the hybrid-electric aircraft propulsion system 300 can be stated as a dynamic optimization problem:

∫ₜ₀^{t1}(P(t)_{electric}+P(t)_{gasturbine}−P(t)_{demand})dt→min

Over a time interval [t0, t1] the difference between the available power (P_{electric}, P_{gasturbine}) and the power demand (P_{demand}) is to be minimized. The hybrid-electric aircraft propulsion system 300 is supposed to generate just enough power to meet the power demand.

As the power terms in the optimization statement are time dependent, the result of the minimization problem is a control profile over time which enables the hybrid-electric aircraft propulsion system 300 to operate according to the objective function of the dynamic optimization problem.

An embodiment of a method discussed in the following, takes into account the following more specific optimization problem:

∫ₜ₀^{t1}(P(t)_{electric}+P(t,tip clearance)_{gasturbine}P(t)_{demand})dt→min

This means that the power output of the gas turbine 309 of the hybrid-electric aircraft propulsion system 300 is controlled by the controller 306 using the tip clearance control system 400 to adjust the tip clearance 401 so that the overall operational profile is optimal. The management of the tip clearance is a combination of an air flow control in the secondary air system and quasi-stationary fuel flow changes enabled by a thrust change through taking into account the batteries and/or fuel cells.

This means the effect of the tip clearance 401 of the compressor stages 14, 17 and/or the turbine stages 17, 18, 19 (see FIG. 1) is considered in the balancing of the power output of the gas turbine 309 and the electric motor 307.

As mentioned above, tip clearance control (TCC) using e.g. air flows from the engine's secondary air system is known in the art. This means that the active control of the air flows in the TCC is a part of the optimization problem solved.

In FIG. 4, the effect of different engine designs and the TCC are shown on tip clearance 401.

A “gas turbine only engine” (upper row) and a “hybrid-electric aircraft propulsion system” 300 (lower row) are compared for the alternatives “no TCC” (left column) and “with TCC” (right column) and the different outcomes for the tip clearances 401 is shown.

In a hot re-slam maneuver (i.e. sudden increase of acceleration starting from a hot disc condition) in a conventional gas turbine engine (e.g. a turbo-fan engine or a geared turbo fan engine) the minimum achievable tip clearance is set. The tip clearance 401 is the sum of the tip clearance for the cruise to MTO range and the tip clearance for the re-slam range: A+C. If a TCC is used with a conventional gas turbine, the casing can be moved radially outward from the hot rotors, reducing the achievable tip clearance to B.

In a hybrid-electric aircraft propulsion system without a TCC, the electric part now covers the step change in a sudden acceleration such as a re-slam. There is no impact of the re-slam. The tip clearance 401 in FIG. 4 is reduced to A.

If a hybrid-electric aircraft propulsion system 300 has a TCC, the optimum tip clearance 401 can be achieved through combined action of the electric system and the TCC (being part of the gas turbine system, see FIG. 3) as both transients and effect due to different time constants or rotor and casing expansion/contraction can be taken into account. The resulting tip clearance 401 is D, which is smaller than B. Using the terminology in FIG. 4, the following holds (A+C)>A>B»D.

In one embodiment, the gas turbine 309 is designed for several operating points. The electrical propulsion system 301 manages the step changes in thrust by a gradual (quasi-steady) change in shaft speed to minimize, if not avoid, the transient movements between static and rotating parts, compensating the missing thrust at MTO or the excessive thrust during decent or idle with the energy storage within the electric system.

In this embodiment, a step change or any other rapid change in thrust or power can be provided by relying on the electric storage unit 307 (battery, supercapacitor, fuel cell system,) whilst keeping the gas turbine 306 operation nearly constant and then gradually adopting it to a new speed required for a new thrust setting. This can be achieved by means of a gradual (quasi-steady) increase in fuel flow, whilst the electrical system compensates for the difference in thrust by charging or discharging the electric storage unit 307. Thereby, the transient movements caused by centrifugal and thermal effects can be minimized, if not entirely avoided.

FIG. 5 shows an operation profile known in the art using constant operation of the gas turbine at a constant working point (rotational speed NH, fuel consumption Wfuel, Temperature T). At the beginning, in idle, the electric storage unit 307 is charged. During the MTO phase, extra power is provided to generate more thrust. Once in cruise mode, the gas turbine 306 is generating all the required thrust. When again in idle mode, the gas turbine 306 operation charges the electric storage unit 307.

FIG. 6 shows an operation profile of an embodiment described herein. The diagram shows the thrust level over time. Delivering the step change in thrust demanded, the thrust is built up by using the gas turbine 306 and the electrical storage unit 307 to achieve the demand thrust profile. That means here, that at before the step change, the thrust is solely delivered by the gas turbine engine 306 and then increasingly delivered by the electric storage unit 306. At all times in this phase the total thrust is achieved by balancing the two power sources, until the demanded thrust level for the idle mode is reached. The ramping-up and the thrusting of is performed under tip clearance control 400 (see FIG. 3), as the increasing rotational speed generally narrows the tip clearance 401. The gradual increase in rotational speed instead of a step change (see FIG. 5) allows a matching of the thermal expansion difference between casing and rotors through the tip clearance control system 400, which can e.g. adjust targeted cold or warm air streams.

The same ramping-up is present in the change from idle mode to MTO mode. Again, the electrical power from the electrical storage unit 307 is augmenting the ramping up through the gas turbine 306.

The reverse takes place when the thrust level is reduced, e.g. from MTO level to cruise level. In this case, some rotational energy is used to charge the electric storage unit 401.

This shows that the embodiment can balance the two power sources 307, 309 of the hybrid-electric aircraft propulsion system 300 to provide an overall optimal flight profile while taking into account the influence of the tip clearance 401.

In FIG. 7, a profile analogue to the one shown in FIG. 6 is depicted with a diagram showing the negative closure of the tip clearance 401 over time. This means that increasing values in negative closure represent larger tip clearances 400 whilst negative closure below zero imply rubs into the segment, leading to permanent opening of the tip clearances due to material wear off. Again, the profile goes from an idle state, a MTO phase, a cruise phase back to an idle state.

At the start, the hybrid-electric aircraft propulsion unit 300 is in idle mode, with the tip clearance 401 a little above the cold built mode. The startup leads to a first transient overshoot in the negative closure, i.e. the tip clearance 401 gets smaller. Similar overshoots or undershoots occur whenever there is a drastic change in the operation regime, e.g. a switch from MTO to Cruise.

In FIG. 8, the profile as in FIGS. 6 and 7 is depicted, showing the negative closure over time as in FIG. 7. Here, the tip clearance under the demanded thrust profile (solid line) is compared against the tip clearance due to the gas turbine engine (dashed line, NH). The difference of the tip clearance 401 is delivered by the electrical system in the cases in which the thrust is ramped-up (e.g. idle to MTO).

Here, it is proposed to implement a control logic in the hybrid-electrical aircraft propulsion system covering thrust increments or decrements arising from the quasi-steady gas turbine operation and the thrust requirement from the aircraft (see FIG. 6) by means of a quasi-steady fuel flow change and a corresponding utilization of the electrical storage system.

This implementation of an embodiment might have at least one of the following potential benefits:
a) It would reduce, if not avoid, the transient effects on the tip clearance 401 due to centrifugal and thermal loads and thereby reduce the achievable tip clearance by up to 75%, increasing compressor and turbine efficiencies by several percent points.
b) Moreover, a positive spill-over effect is predicted on the deterioration as the hot gas exposure of the turbine blade tips as well as transient TGT overshoots are reduced and also.
c) The requirement for a tip clearance control system 400 might be reduced in complexity due to smaller relative movements between casing and rotating parts to be controlled.
d) The option of an alternative electric storage unit 307 from outside the gas turbine 306 can also be exploited to improve the wind-mill relight capability of a gas turbine engine as there is no dependency from another gas turbine, as an APU.
e) Even for a turbo-shaft application with a “more electric” approach, an electric “customer” attached to one of the shafts could offer a means to control the transients, ideally by storing the power produced in a generator mode such that it can be re-used during the motor mode of operation.
f) Lastly, for a two-shaft engine with an electric motor 303 on each shaft, power can be transferred from one shaft to the other to control the speed change and tip clearance without any energy storage. For example: If HP is most critical for tip clearance 401, then for an acceleration increase the fuel flow while drawing power from the HP shaft electric machine and injecting the power to the FPT electric machine is used to boost the output. The HP spool would thus not speed up as rapidly and the tip closure would be limited. Conversely, on a deceleration as the fuel flow is decreased power from the FPT attached generator could be injected back into the HP attached generator to retain the RPM and tip closure 401. As the casing cools, the power injection would be reduced to maintain the tip clearance. Alternatively, a control logic accelerating or decelerating the power turbine shaft down with the generator working as motor or brake could be envisaged.

### LIST OF REFERENCE NUMBERS

10 gas turbine engine
11 principal and rotational axis
12 air intake
13 propulsive fan
14 intermediate pressure compressor
15 high-pressure compressor
16 combustion equipment
17 high-pressure turbine
18 intermediate pressure turbine
19 low-pressure turbine
20 exhaust nozzle
21 nacelle
22 bypass duct
200 control and monitoring system
201 turbofan engine
202 engine electronic control (EEC)
203 engine monitoring unit (EMU)
204 monitoring sensors
205 control sensors
206 engine effectors
207 airframe avionics
300 hybrid-electric aircraft propulsion system
301 electric propulsion unit
302 fan, propulsor
303 electric motor
304 central shaft
305 nacelle
306 controller
307 electric storage unit
308 generator
309 gas turbine engine
400 tip clearance control system
401 tip clearance

1. A control method operating with a hybrid-electric aircraft propulsion system comprising a generator system, a propulsor, a controller and an electric storage unit,
the generator system comprising:
a gas turbine having a plurality of rotor blades surrounded by a casing, the rotor blades separated from the casing by a tip clearance; and
an electric generator arranged to be driven by the gas turbine, the propulsor, in particular a fan, with an electric motor arranged to drive the propulsor;
the controller configured to operate the gas turbine and to control the supply of electric power between the electric motor, the electric storage unit and the electric generator in response to a demand for thrust,
the method comprising the controller in cooperation with a tip clearance controller:
receiving a command for a change in demand for thrust;
determining an operational profile that minimizes a function comprising a measure of fuel supplied to the gas turbine, a transfer of electric power from or to the electric storage unit, a difference between measures of current and demanded thrust and the tip clearance over a time period; and
operating the electric motor, the gas turbine and the electric storage unit according to the determined operational profile over the time period.

2. The control method according to claim 1, in which a step change in the operational profile is in part performed by power obtained from the electrical storage unit.

3. The control method according to claim 2, wherein the gas turbine provides a ramp-up change in the operational profile, while the power obtained from the electrical storage unit makes up the difference to the required power to generate the step change in the operation profile.

4. The control method according to claim 1, wherein decrease in thrust is generated by a step change for the gas turbine, the rotational energy available due to the decrease in the thrust being used to charge the electrical storage unit.

5. The control method according to claim 1, where power obtained from the electrical storage unit is used to generate of gradual, quasi-steady increase in fuel flow, whilst the electrical system compensates for the difference in thrust by charging or discharging the electrical storage system.

6. The control method according to claim 1, wherein the operational profile maintains the tip clearance at predetermined tolerance, in particular a time dependent tolerance.

7. The control method according to claim 1, comprising the controlling of the tip clearance between the rotor blades and the casing by controlling a supply of cooling and/or heating air to the casing and/or controlling movement of the casing relative to the rotor blades.

8. The control method according to claim 1, wherein the hybrid-electric aircraft propulsion system is part of a propulsion system of an aircraft or a helicopter.

9. A computer program for instructing a computer-implemented controller to perform the method of claim 1.

10. A control system for operating a hybrid-electric aircraft propulsion system comprising a generator system, a propulsor, a controller and an electric storage unit,
the generator system comprising:
a gas turbine having a plurality of rotor blades surrounded by a casing, the rotor blades separated from the casing by a tip clearance; and
an electric generator arranged to be driven by the gas turbine, the propulsor, in particular a fan, with an electric motor arranged to drive the propulsor;
the controller configured to operate the gas turbine and to control the supply of electric power between the electric motor, the electric storage unit and the electric generator in response to a demand for thrust, the controller being in cooperation with a tip clearance controller particularly arranged and designed for
receiving a command for a change in demand for thrust;
determining an operational profile that minimizes a function comprising a measure of fuel supplied to the gas turbine, a transfer of electric power from or to the electric storage unit, a difference between measures of current and demanded thrust and the tip clearance over a time period; and
operating the electric motor, gas turbine and electric storage unit according to the determined operational profile over the time period.
